(19) United States
(12) Patent Application Publication
(10) Pub. No.: US 2018/0290405 A1
(43) Pub. Date: Oct. 11, 2018

(54) METHOD FOR PRODUCING A PART MADE OF A COMPOSITE MATERIAL, INCORPORATING COMPONENTS AND MARKING MEANS

(71) Applicant: UNIVERSITÉ DE TECHNOLOGIE DE BELFORT-MONTBÉLIARD, Belfort Cedex (FR)

(72) Inventors: Rémy LACHAT, Valdoie (FR); Yann MEYER, Baume-Les-Dames (FR)

(73) Assignee: UNIVERSITE DE TECHNOLOGIE DE BELFORT-MONTBELIARD

(21) Appl. No.: 15/746,584

(22) PCT Filed: Jul. 19, 2016
(86) PCT No.: PCT/FR2016/051846

§ 371 Date: Jun. 25, 2018

(30) Foreign Application Priority Data
Jul. 21, 2015 (FR) 1556912

(51) Int. Cl. B29C 70/54; B29C 70/30; B29C 70/86; B29C 70/88

(52) U.S. Cl. CPC B29C 70/543; B29C 70/88; B29C 70/865; B29C 70/30

(57) ABSTRACT

Some embodiments are directed to a method for producing a part made of a composite material. The method can include arranging at least two reinforcing plies on a first molding face of a mold; impregnating the reinforcing plies with a hardenable resin. A preform is provided between the reinforcing plies, and the preform includes at least two components and a marker for defining or marking the position of the preform and the components in the part.

### CROSS REFERENCE TO RELATED APPLICATIONS

This application is a national phase filing under 35 C.F.R. § 371 of and claims priority to PCT Patent Application No. PCT/FR2016/051846, filed on Jul. 19, 2016, which claims the priority benefit under 35 U.S.C. § 119 of French Patent Application No. 1556912, filed on Jul. 21, 2015, the contents of each of which are hereby incorporated in their entireties by reference.

### BACKGROUND

Some embodiments relate to a method for producing a part made of a composite material incorporating components.

Composite materials are already widely used for producing, for example, large awkwardly shaped parts, such as structure or bodywork elements in the field of automotive, railroad or aeronautical transport. The present tendency is to attempt to lighten the structures further, for example by using carbon fiber reinforcement. However, the behavior of such elements is substantially different from that of known elements based on glass fiber and resin, such as polyester or epoxy resin. This is because the vibratory response is substantially modified, resulting in degraded acoustic performance and affecting the service life of the elements.

U.S. Pat. No. 5,894,651 proposes to incorporate components such as piezoelectric actuators in the composite part, enabling mechanical vibrations to be absorbed in an active manner. The actuators take the form of ceramic disks. US 2004/070314 A1 and US 2002/038990 A1 disclose the use of piezoelectric elements, which are flexible so that they can be shaped to fit awkward surfaces.

### SUMMARY

Such components must be positioned in a precise way in the part in order to have the specified effect on the dynamic behavior of the part. The individual placing of each component, by a manual or even a robotic method, is laborious and imprecise.

Some embodiments are directed to a method for producing parts made of composite material, which enables components to be placed in a precise way.

Some of these embodiments are particularly directed to a method for producing a part made of composite material, the method including:
laying at least two reinforcing plies on a first mold face of a mold;
impregnating the reinforcing plies with a hardenable resin;

wherein a preform is placed between the reinforcing plies, the preform including at least two components and a marker for defining or marking the position of the preform and the components in the part.

By using a preform, the components can be placed in a precise relative position. The preform is then incorporated into the final part, providing a precise relative position of the components in the final part. The position of the preform in the part may also be set or adjusted with the aid of the marker. The impregnation may be carried out for contact molding, using a single mold face, or by infusion or low pressure molding, using a mold closed by a second mold face put in place after the plies and before impregnation.

According to one embodiment, the marker includes at least two centering holes passing through the preform, and the preform is placed on the first mold face by making the centering holes coincide with pins fixed to the mold. The position of the preform is defined in a positive way relative to the mold, and therefore relative to the final part. The centering pins may be fixed, in which case the final part includes corresponding holes, or may be retractable after the positioning of the preform, to make the part continuous.

In one example, the pins project from the first mold face. The preform may thus be entirely embedded in the molded part.

In another example, the pins are outside the first mold face. In this case, the preform overlaps the boundaries of the molded portion of the part. This overlapping portion is either retained, or cut off if it interferes with the function of the part.

According to another embodiment, the marker includes edges of the preform, and the edges are placed to bear on stop faces of the mold to position the preform. Thus, stop faces adapted to the outer shapes of the preform are provided, and the preform is wedged between these faces.

For example, the stop faces are outside the first mold face. Thus, portions of the preform overlap the boundaries of the molded portion. These overlapping portions are either retained, or cut off if they interfere with the function of the part.

According to another embodiment, the marker includes contactless inserts. They may be metal portions or magnets whose position may be marked by the exploration of the magnetic field created by the insert or by its interference with a magnetic measurement field. They may also include a visual component, if the preform and plies allow them to be viewed.

According to another embodiment, the edges of the part are cut off so that its boundaries are in position relative to the marker. In production techniques for composite parts, it is not always easy to place the boundaries of the part in a precise way. Since a number of plies are superimposed and the edges of the plies are not always aligned, the quality of the edge of the raw part is not always satisfactory. Cutting is therefore carried out to ensure the quality of the boundary of the part and of its position relative to the marker and to the components.

According to an optional characteristic of some embodiments, the preform includes at least one preform ply to which components are fixed. The preform ply is impregnated with the same resin as the part during its production. The components are fixed by any suitable device or method, such as adhesion, binding or clamping. The preform is perfectly or substantially perfectly incorporated in the final part.

According to another option, the preform includes at least one preimpregnated preform ply to which the components are fixed. The resin is already incorporated into the preform, but is not hardened; it will be hardened at the same time as the part. The resin may thus act as an adhesive for securing the components. The preform will thus be perfectly incorporated into the final part.

According to another option, the preform includes at least one preform ply embedded in hardened resin. The preform is thus partially rigid, with the components already incorporated into the hardened resin. The preform may thus be handled easily without any risk of displacing the components, thereby ensuring maximum precision.

According to an enhancement or improvement, the components are interconnected by electrical conductors incorporated into the preform. The operation of connecting the components is thus carried out on the preform, which is easier than carrying out this operation on the mold of the final part. Furthermore, quality tests may be conducted on the preform before its incorporation into the final part.

For example, the first mold face is awkwardly shaped. Even if the preform has been produced in the flat state, it may be shaped, because of its flexibility, to fit the awkward shape of the first mold face.

Some embodiments are also directed to a part made of composite material, including at least two reinforcing plies embedded in hardened resin, which includes, between the plies, a preform including at least two components and a marker, which have defined, or allowed the marking of, the position of the preform and the components in the part.

### BRIEF DESCRIPTION OF THE DRAWINGS

Some embodiments will be more readily understood, and other features and advantages will be apparent, from the following description, which refers to the attached drawings, in which:

FIG. 1 is a perspective view of a part made according to a method of an embodiment;

FIG. 2 is a view of a preform incorporated into the part of FIG. 1;

FIG. 3 is an exploded view illustrating the method of preparing a part according to a first embodiment;

FIG. 4 is a perspective view of the part prepared according to FIG. 3;

FIG. 5 is an exploded view illustrating the method of preparing a part according to a second embodiment;

FIG. 6 is a perspective view of the part prepared according to FIG. 5;

FIG. 7 is an exploded view illustrating the method of preparing a part according to a third embodiment;

FIG. 8 is an exploded view illustrating the method of preparing a part according to a fourth embodiment;

FIG. 9 is a perspective view of the part prepared according to FIG. 8;

FIG. 10 is a perspective view illustrating the preform used by the method of preparing a part according to an embodiment;

FIG. 11 is a perspective view of the part prepared with the preform of FIG. 10;

FIGS. 12 to 14 are perspective views of examples of preforms placed on awkwardly shaped surfaces.

### DETAILED DESCRIPTION OF THE EMBODIMENTS

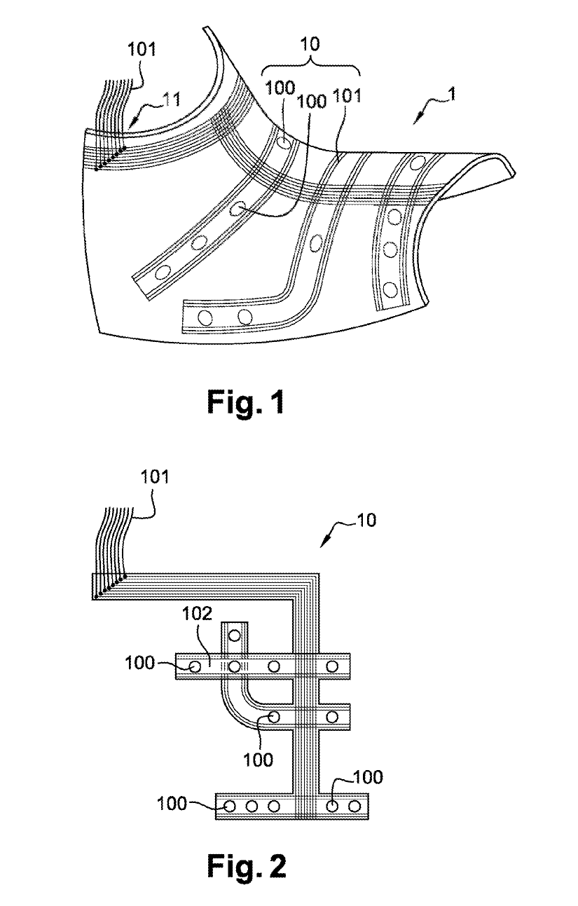

A part 1 made by the method according to some embodiments is shown in FIG. 1. This awkwardly shaped part 1 incorporates within its thickness components 100, such as piezoelectric disks connected by electrical conductors 101. The components 100 and the conductors 101 are taken from a preform 10, such as that shown in FIG. 2. The preform 10 is substantially flat, with a contour in the shape of a tree with a number of branches 102, each branch 102 including one or more components 100. The electrical conductors 101 pass out together from one of the edges 11 of the part 1.

The part 1 is made of composite material and is produced by the following method:
at least a first reinforcing ply 12 is placed on a first mold face 21 of a mold 2;
a preform 10 is placed on the plies 12 that are already in place, the preform 10 including at least the components 100 and a marker 3;
at least a second reinforcing ply 13 is placed on top of the preform 10;
the reinforcing plies 12, 13 are impregnated with a hardenable resin;
after waiting for hardening, the part 1 is removed from the mold 2.

The reinforcing plies 12, 13 can be made in accordance with the related art, of fibers, such as fibers of glass, aramid, carbon or plant matter. The resin can be chosen, in accordance with the related art, from among epoxy, polyester, vinyl ester, polyimide, phenolic, polypropylene and polyamide resins, for example.

The preform 10 may be made by various procedures.

In a first procedure, the preform 10 includes at least one preform ply 101 to which components 100 are fixed. The components 100 are fixed, for example, by adhesion to the ply. A plurality of layers of preform plies 101 may be provided. The preform ply 101 will be impregnated with resin at the same time as the reinforcing plies 12, 13 belonging to the part 1. The result is that the preform 10 is closely linked to the part 1.

In a second procedure, the preform 10 includes at least one preimpregnated ply to which the components 100 are fixed. In this case, the preimpregnation resin may be of the same kind as, or of a different kind from, that used for the rest of the part 1, depending on the properties to be given to the part. The resin is hardened in accordance with the related art by exposure to ultraviolet radiation or heat.

In another procedure, the preform 10 includes at least one ply embedded in hardened resin. The preform 10 is thus easily handled and the relative positioning of the components 100 is ensured.

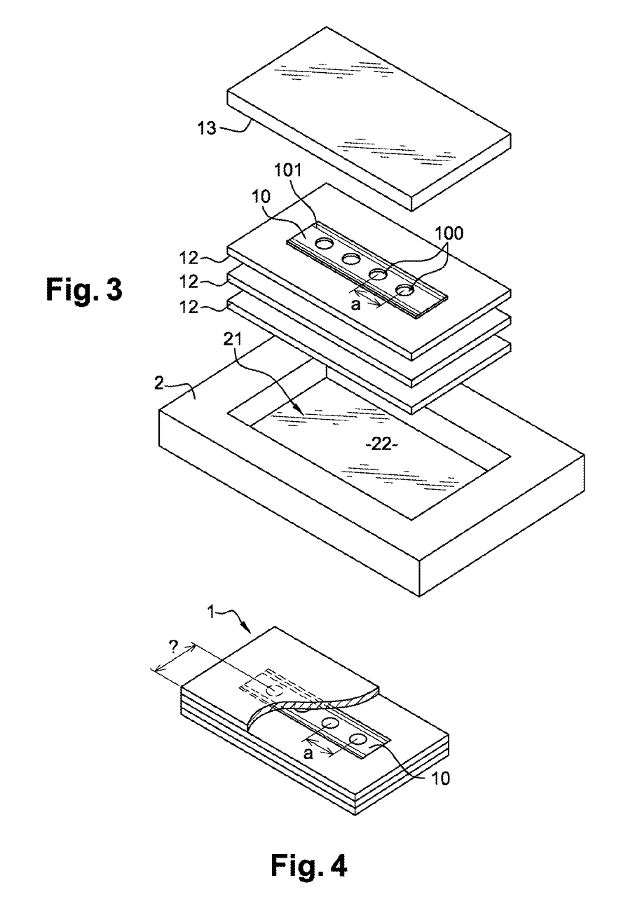

In a first embodiment of the method, as shown in FIGS. 3 and 4, a mold 2 is used, having a cavity 22 in which three first reinforcing plies 12, the preform 10, and a second reinforcing ply 13 are placed in succession. The preform 10 includes a number of components 100 distributed in a predetermined way, as indicated by the dimension “a” between two components 100. The components 100 contain the marker 3 so that they can be located in the finished part 1, as shown in cut-away form in FIG. 4. The dimension “a” found in the finished part 1 is also indicated.

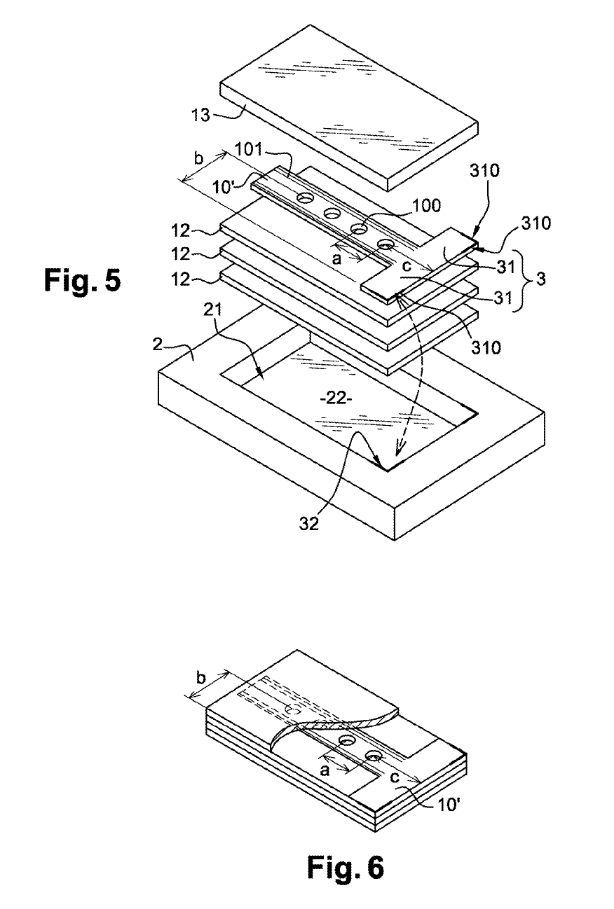

In a second embodiment, as shown in FIGS. 5 and 6, the same mold 2 as in the first embodiment is used, but the preform 10′ is equipped with the marker 3 in the form of lugs 31, whose edges 310 bear on the stop faces 32 of the mold 2, for positioning the preform 10′. In this case, the stop faces 32 are three faces extending perpendicularly to the first mold face 21 and intended to delimit the part 1. In the two FIGS. 5 and 6, the dimensions “a” showing the distance between the components 100 and the dimensions “b” and “c” showing the distance of the components 100 from the stop faces 32 are highlighted. Clearly, therefore, the position of the components 100 in the finished part 1 is perfectly or substantially perfectly determined.

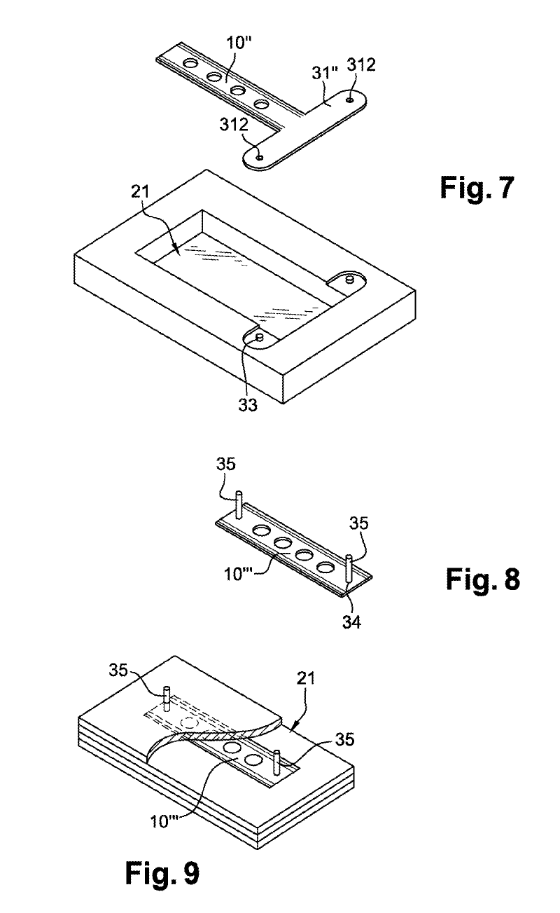

In a third embodiment, illustrated by FIG. 7, provision is made, by contrast with the second embodiment, to extend the two lugs 31″ beyond the first mold face 21, and to equip these lugs 31″ with centering holes 312 passing through the preform 10″, and the preform 10″ is placed on the first mold face 21 by making the centering holes 312 interact with pins 33 fixed to the mold 2. The portions of the lugs 31″ that overlap the boundaries of the mold face 21 are not impregnated with resin in the impregnation step. The overlapping ends of the lugs 31″ are cut off subsequently. In a variant which is not shown, no pins are used, but the projecting portions of the lugs 31″ bear on stop surfaces outside the first mold face 21.

In a fourth embodiment, illustrated by FIGS. 8 and 9, centering holes 34 in the preform 10″′ and pins 35 projecting from the first mold face 21 are provided, so as to fix the position of the preform 10″′ before the impregnation step. The pins 35 may remain in place during the impregnation phase, so that the centering holes 34 will remain present on the part 1. This embodiment is essentially applicable to the case in which the first mold face is not delimited, so that the boundaries of the part 1 may vary widely and cannot act as position markers. In a variant which is not shown, the edge 15 is marked relative to contactless inserts, such as magnets, placed for example in place of the holes 34. The production of the part 1 proceeds as in the first embodiment. When the part 1 is hardened, the position of the inserts is marked, and the edges of the part 1 are cut so that its boundaries 15 are at a specified distance from the contactless inserts 34, as illustrated by the dimension “c” in FIG. 11. The cutting of the edges of the part may also be applicable to the fourth embodiment.

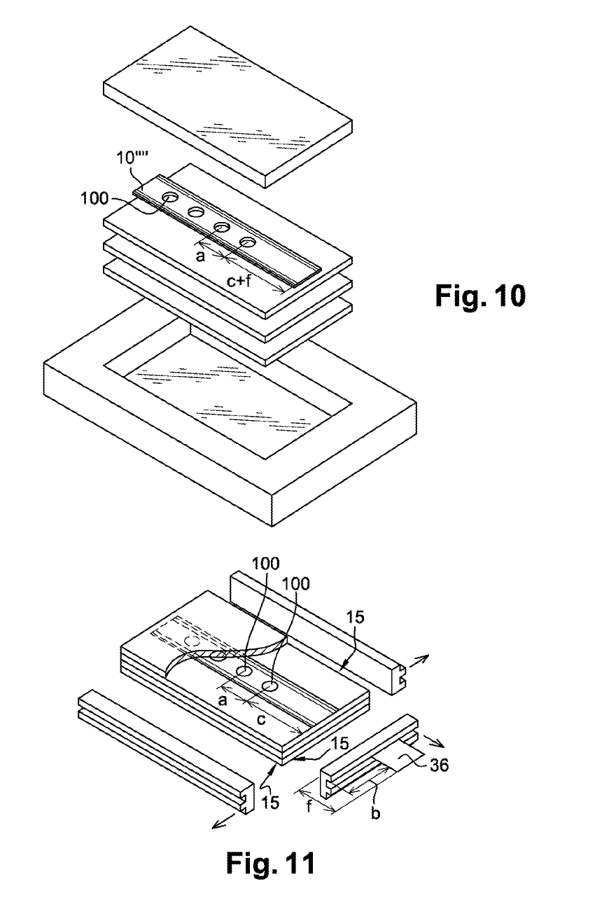

In a fifth embodiment, illustrated by FIGS. 10 and 11, provision is made to extend the preform as a marker. The distance between the first element 100 and the outer edge of the preform is controlled, as illustrated by the dimension “c+f”. The production of the part proceeds, the preform 10″′ being made to overlap beyond the impregnation area. When the part is hardened, the position of the first element 100 is marked by the projecting portion 36 of the preform. The edges of the part 1 are then cut so that the boundaries 15 are at a specified distance from the first element, as illustrated by the dimensions “c” and “b” in FIG. 11.

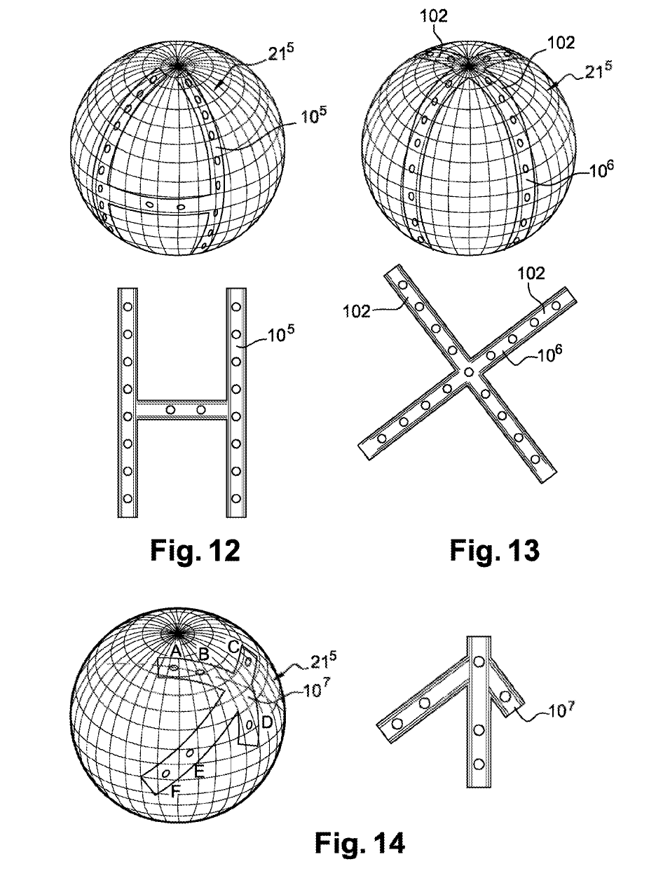

FIGS. 12 to 14 illustrate embodiments in which the first mold face 21⁵ is awkwardly shaped, being spherical in this instance. Although prepared in the flat state, the preform 10⁵, 10⁶, 10⁷ is flexible enough to be adapted to the first mold face 21⁵. It is thus possible to make branches 102 of the preform 10⁶ intersect on the first mold face 21⁵, as shown in FIG. 13.

1. A method for producing a part made of composite material, the method comprising:
placing at least two reinforcing plies on a first mold face of a mold;
impregnating the reinforcing plies with a hardenable resin; and
placing a preform between the reinforcing plies, the preform including at least two components and a marker for defining or marking the position of the preform and the components in the part.

2. The method as claimed in claim 1, wherein the marker include at least two centering holes passing through the preform, and the preform is placed on the first mold face by making the centering holes coincide with pins fixed to the mold.

3. The method as claimed in claim 2, wherein the pins project from the first mold face.

4. The method as claimed in claim 2, wherein the pins are outside of the first mold face.

5. The method as claimed in claim 1, wherein the marker includes edges of the preform, and the edges are placed to bear on stop faces of the mold to position the preform.

6. The method as claimed in claim 5, wherein the stop faces are outside of the first mold face.

7. The method as claimed in claim 1, wherein the marker includes contactless insert.

8. The method as claimed in claim 1, wherein the edges of the part are cut off so that its boundaries are in position relative to the marker.

9. The method as claimed in claim 1, wherein the preform includes at least one preform ply to which components are fixed.

10. The method as claimed in claim 1, wherein the preform includes at least one pre-impregnated preform ply to which the components are fixed.

11. The method as claimed in claim 1, wherein the preform includes at least one preform ply embedded in hardened resin.

12. The method as claimed in claim 1, wherein the components are interconnected by electrical conductors incorporated into the preform.

13. The method as claimed in claim 1, wherein the first mold face is awkwardly shaped.

14. A part made of composite material, comprising:
at least two reinforcing plies embedded in hardened resin; and
a preformed disposed between the plies, the preform including at least two components and a marker, which have defined, or allowed the marking of, the position of the preform and the components in the part.

15. The method as claimed in claim 2, wherein the edges of the part are cut off so that its boundaries are in position relative to the marker.

16. The method as claimed in claim 3, wherein the edges of the part are cut off so that its boundaries are in position relative to the marker.

17. The method as claimed in claim 4, wherein the edges of the part are cut off so that its boundaries are in position relative to the marker.

18. The method as claimed in claim 5, wherein the edges of the part are cut off so that its boundaries are in position relative to the marker.

19. The method as claimed in claim 6, wherein the edges of the part are cut off so that its boundaries are in position relative to the marker.

20. The method as claimed in claim 7, wherein the edges of the part are cut off so that its boundaries are in position relative to the marker.
